(19) United States
(12) Patent Application Publication
(10) Pub. No.: US 2019/0025996 A1
(43) Pub. Date: Jan. 24, 2019

(54) COMPUTER SCREEN DISPLAY FAST SCROLLING AND SWIPING OPERATION FOR TOUCH SCREEN

(71) Applicant: Gilchrist Patrick Lavinier, Houston, TX (US)

(72) Inventor: Gilchrist Patrick Lavinier, Houston, TX (US)

(21) Appl. No.: 15/657,168

(22) Filed: Jul. 23, 2017

(51) Int. Cl. G06F 3/0485; G06F 3/041; G06F 3/01; G06F 3/0488; G06F 3/0481

(52) U.S. Cl. CPC G06F 3/0485; G06F 3/0416; G06F 3/0412; G06F 3/04883; G06F 3/04817; G06F 3/017

(57) ABSTRACT

A computer device having a central processing unit, a memory accessible by the processing unit, and a touch sensitive display for displaying received data and providing a graphical user input for controlling the computer device. A communication module associated with the CPU for communicating over the internet and providing for communicating data between the computer device and a website hosted on a computer server. The memory stores a fast scrolling program that, when active, processes visual data using inputs on the touch sensitive display allowing for fast manipulation of data changing the displayed data at a rate of at least 5 pages of displayed data per second. The manipulation of the displayed data corresponds to a directional input from a touch sensitive directional icon controlling the data processing of the visual data for display.

### CROSS-REFERENCE TO RELATED APPLICATION(S)

Not applicable

### BACKGROUND OF THE INVENTION

### 1. Field of Invention

The present invention relates to computer graphical user interface (GUI) field of computers and related devices, more particularly to manipulating and processing display of data.

### 2. Description of Related Art

Data processing and display on touch screen computer screens typically depends on users scrolling and swiping the screen to manipulate and process the data. Scrolling typically depends on a user moving their finger in physical contact with the screen up and down. This causes the computer to process data for display vertically essentially causing a scrolling movement effect as pages of data move up or down on the display. Swiping typically depends on a user moving their finger in physical contact with the screen side-to-side (i.e., left or right). This causes the computer to process data for display horizontally essentially causing a back and forth movement effect as pages of data move left or right on the display.

On newer tablet and smart phones designed for prolonged internet usage and review of large amounts of data, the constant movement of fingers on touch sensitive display screen can become tedious and frustrating. Small display sizes can require many manipulations to position the data in a proper position for viewing. Depending on the size of the data files being manipulated, and the user's requirements for accessing that data for viewing, a user may require tens of manipulations within a brief period of time to access the data. These manipulation take considerable time and can even become painful.

Based on the foregoing, there is a need for a data processing procedure to speed up the processed movement of the data displayed and reduce the number of physical manipulation by the finger to access the data.

### SUMMARY OF THE INVENTION

In an embodiment, a computer device, comprising a central processing unit, a memory accessible by the processing unit, and a touch sensitive display screen for displaying received data and providing a graphical user input for controlling the computer device. The device includes a communication module for communicating over the internet and providing for communicating data between the computer device and a website hosted on a computer server. A fast scrolling program is stored in the memory, and the fast scrolling program, when active, processes visual data using inputs on the touch sensitive display screen allowing for fast manipulation of data for changing the displayed data at a rate of at least 5 pages of displayed data per second, and the manipulation of the displayed data corresponds to a directional input from a touch sensitive directional icon controlling the data processing of the visual data for display.

In an embodiment, the fast scrolling program activates via a drop down menu.

In an embodiment, the fast scrolling program activates via a pop up on the touch sensitive screen.

In an embodiment, the scrolling program directional input can be accomplished using a least one of a) a finger, b) an input from an external mouse; and c) an input from an external keyboard.

In an embodiment, the touch sensitive directional icon comprises two opposing pairs of directional arrows, with a first pair oriented in an up and down configuration and a second pair oriented in a left and right configuration.

In an embodiment, the computer device comprises a tablet or a smart phone.

In an embodiment, a method of operating a computer device to process visual data, comprises providing a central processing unit, a memory accessible by the processing unit, and a touch sensitive display screen for displaying received data and providing a graphical user input for controlling the computer device. The computer communicates with a website server to access and retrieve webpage visual data, and an activated fast scrolling program stored in said memory operates to process the visual data received from a website server using inputs on the touch sensitive display for fast manipulation of data to change the displayed data at a rate of at least 5 pages of displayed data per second, the manipulation of the displayed data corresponds to a directional input from a touch sensitive directional icon controlling the data processing of the visual data for display.

In an embodiment, a method of operating a computer device to process visual data by providing a central processing unit, a memory accessible by the processing unit, a touch sensitive display screen for displaying received data, and a user interface input controlling the computer device. The computer communicates with a website server to access and retrieve webpage visual data using an activated fast scrolling program stored in said memory. The computer processes the visual data received from a website server using the fast scrolling program, where the fast scrolling program uses inputs to the processing unit for fast manipulation of data to change the displayed data at a rate of at least 5 pages of displayed data per second, and the manipulation of the displayed data corresponds to a directional input from a user interface controlling the data processing of the visual data for display.

In an embodiment, a computer device accesses a webpage and includes a central processing unit, a memory accessible by the processing unit, a display for displaying received data, and a user interface for controlling the computer device. A communication module communicates over the internet and providing for communicating data between the computer device and the webpage hosted on a computer server. A fast scrolling program stored in the memory, when active, processes visual data using inputs from the user interface allowing for fast manipulation of data for changing the displayed data at a rate of at least 5 pages of displayed data per second. The manipulation of the displayed data corresponds to a directional input from the user interface controlling the data processing of the visual data for display.

In an embodiment, the user interface comprises a touch sensitive display screen, a keyboard, or a mouse.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is an exemplary schematic block diagram of the functional components of a tablet computer according to an embodiment of the present invention;

FIG. 2 is a an exemplary embodiment of a user manipulating the display of data on a touch sensitive display screen according to an embodiment of the present invention; and

FIG. 3 is an exemplary view of the touch sensitive display screen with the touch sensitive icon of the fast scrolling and swiping active and visible according to an embodiment of the present invention.

### DETAILED DESCRIPTION OF PREFERRED EMBODIMENTS

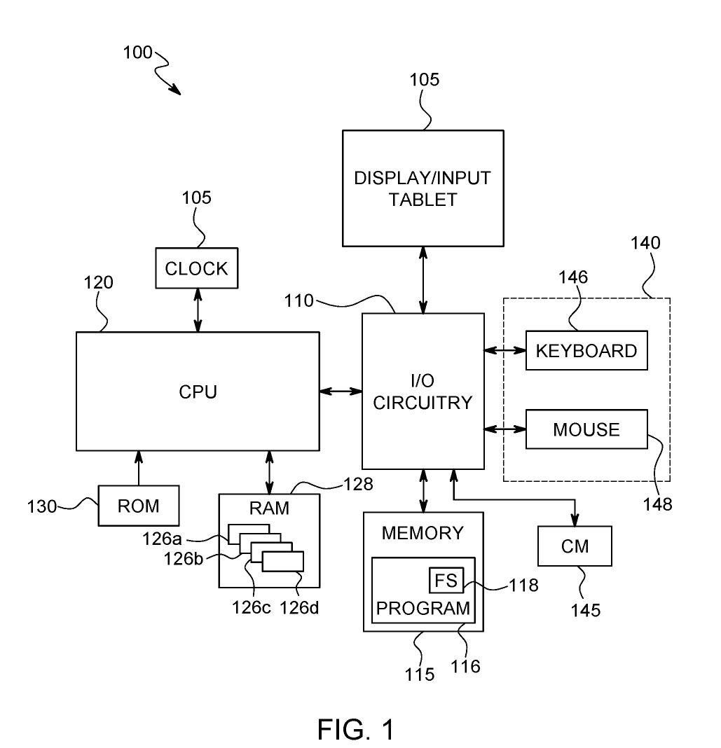

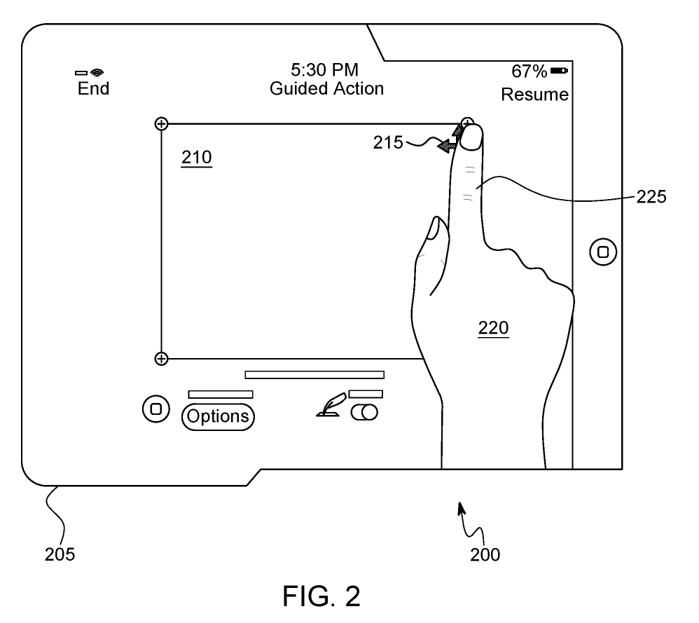

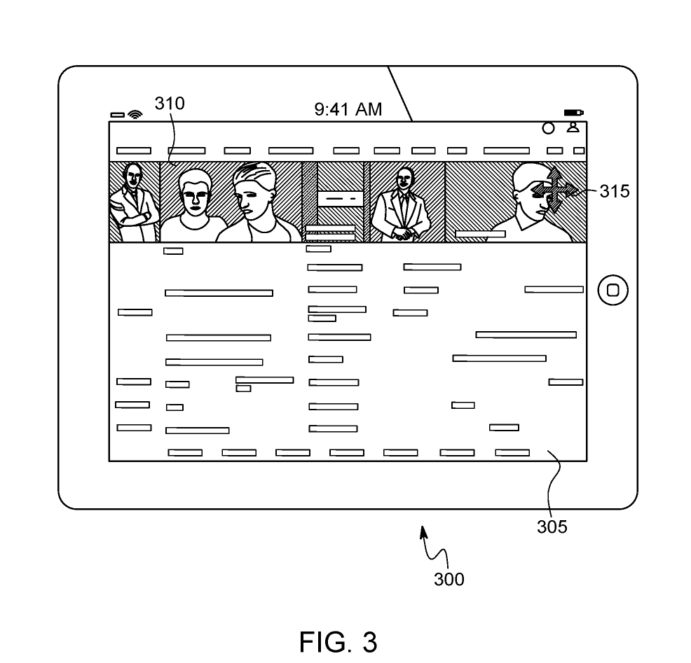

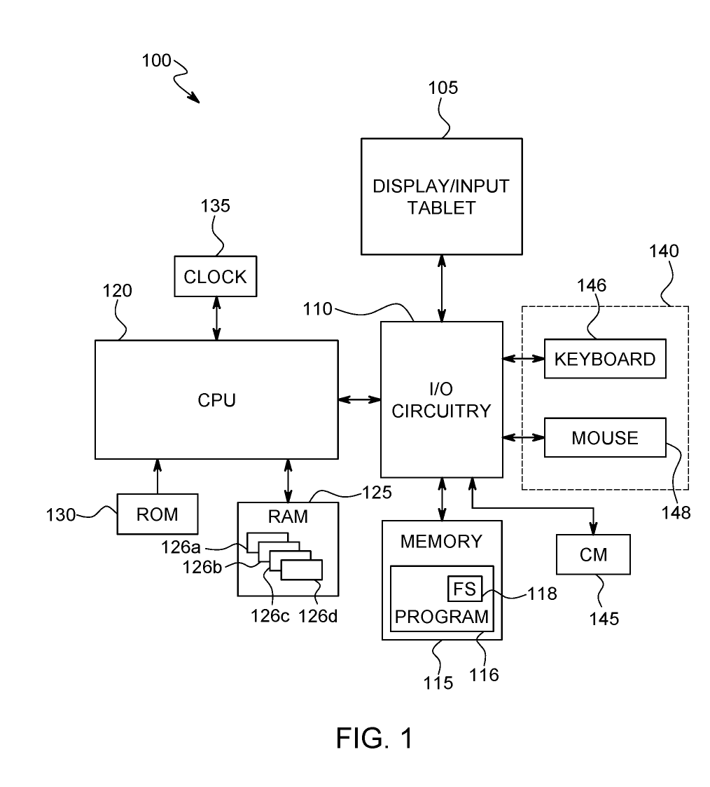

Preferred embodiments of the present invention and their advantages may be understood by referring to FIGS. 1-3, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

The computer memories in the various disclosed devices may store computer executable instructions. Each disclosed computer/communication device such as computer, a server, a system node, a smart phone, a tablet, or similar device able to execute computer code and/or process digital, electronic data may execute computer executable instructions. The computer executable instructions may be included in computer code. The computer code may be stored in the various device memories. The computer code may be written in any computer language comprising the prior art. The memory may be a non-transitory tangible storage media.

The computer code may be logic encoded in one or more tangible media or one or more non-transitory tangible media for execution by the processor in the devices. Logic encoded in one or more tangible media for execution may be defined as instructions that are executable by the processor and that are provided on the computer-readable storage media, memories, or a combination thereof. Logic may include a software controlled microprocessor, an application specific integrated circuit (ASIC), an analog circuit, a digital circuit, a programmed logic device, a memory device containing instructions, and the like. The instructions may be stored on any computer readable medium comprising the prior art from which a computer, a processor, or other electronic device can read. This may include a computer data disk or the like storing computer code that can be used to configure a memory associated with a computer, a processor, or other electronic device.

The processor may include a general processor, digital signal processor, ASIC, field programmable gate array, analog circuit, digital circuit, central processing unit (CPU), micro-processor unit (MPU), micro-controller unit (MCU), combinations thereof, or other now known processor. The processor may be a single device or combinations of devices, such as associated with a network or distributed processing. The processor may be responsive to or operable to execute instructions stored as part of software, hardware, integrated circuits, firmware, micro-code or the like. The functions, acts, methods or tasks illustrated in the figures or described herein may be performed by the processor executing instructions stored in the memory.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

As depicted in FIG. 1, a schematic block diagram 100 shows the internal components of a computer tablet (or similar computer device) that can comprise a display 105 comprising a touch sensitive screen functioning as a graphical user interface (GUI), input/output (I/O) circuity 110 for processing and routing input and output data, memory 115 storing digital data, which can include computer programs (in the form of executable program code) 116, including the fast scrolling program 118 of the invention, a central processing unit (CPU) 120, with associated Random Access Memory (RAM) 125 consisting of RAM modules 126a, 126b, 127c, and 126d, Read Only Memory (ROM) 130, a clock 135 regulating the function of the tablet, and external hardwire 140 that may be attached, such as a keyboard 146 or a mouse 148, which also can serve as a GUI. However, typically touch inputs on the touch sensitive display 105, which may also include virtual graphical analogues of the mouse 148 and keyboard 146. Finally, the tablet can include a communication module (CM) 145 for accessing the internet and transmitting or receiving data between the tablet and external data sources, such as a computer server hosting an internet accessible website.

In operation, the CPU 120 can access through I/O circuitry 110 memory 115 storing programs 116 and the fast scrolling program 118 of the invention. The CPU 120 can execute the programs 116 as well as processing any stored digital data in memory 115. The CPU 120 can also operate to process data received or transmitted via communication module 145 using I/O circuitry 110. The CPU 120 can process received data from or transmitted to communication module 145 as well as data manipulation inputs from the display/input screen 105 of the tablet or exterior hardware 140. The touch sensitive screen forming display/input screen 105 can receive data inputs reflecting scrolling or swiping movements of a user's finger, which the CPU 120, utilizing executed programs from memory 115, uses to process data received from communication module 145 to display that data reflecting those scrolling and swiping inputs from a user on screen 105.

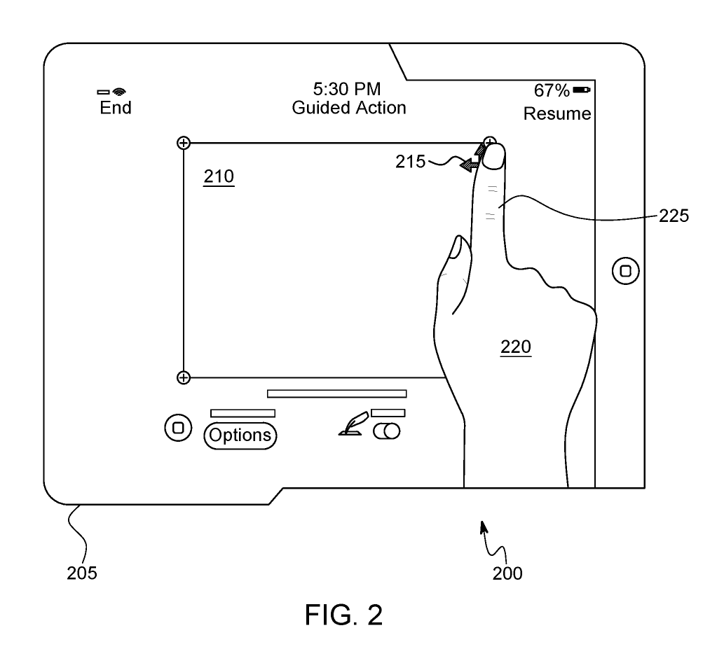

As depicted in FIG. 2, a user can utilize the fast scrolling program 118 to view an internet page. Tablet 200 can include a touch sensitive screen 205. As depicted, screen 205 can display an interactive website page 210 (hosted on a website computer server), which is a product of visual, and in some embodiments, audio data transmitted and processed by the CPU 120 of tablet 200 to present to a user. The tablet 210 can provide an interactive display of data transmitted to the tablet 200 using communication module 145, responsive to user inputs using the touch sensitive screen 205 or other GUI components. As depicted, the touch sensitive screen 205 can display the interactive touch sensitive directional fast scrolling icon 215 partially obstructed by finger 225 of user hand 220. The interactive touch sensitive directional fast scrolling icon 215 responds to finger 225 by causing the displayed data to move up and down or right to left corresponding to the directional arrow-shaped arm of interactive touch sensitive directional fast scrolling icon 215.

In normal operation, the fast scrolling program 118 typically is normally inactive. In an embodiment, fast scrolling program 118 can be activated/turned on by accessing a drop down menu on interactive touch sensitive screen 205 or a pop up on the interactive touch sensitive screen 205 comprised of the interactive touch sensitive directional fast scrolling icon 215 that display when the user double-taps the touch sensitive screen 205. Once the interactive touch sensitive directional fast scrolling icon 215 becomes visible, finger 225 can move up or down, left or right, by just lightly pressing the corresponding arrow of the interactive touch sensitive directional fast scrolling icon 215, to cause the data displayed to be processed according to the “movement.” In some embodiments, the device, such as tablet 200 or another device (smart phone, PDA, computer, etc), can respond to a hovering finger 225 Once the interactive touch sensitive directional fast scrolling icon 215 is active and being used, the displayed webpage 210 “moves” faster than finger 225 can in conventional scrolling operations. Large webpages can be easily manipulated to view the large amount of data without constantly moving one's finger over the touch sensitive screen 205, avoiding finger pain. A contemplated scrolling speed of 5 to 57 pages per second may be configured in the fast scrolling program, and the selection can be modified during use or configured in a displayed “options” pane. The term “pages per second” is the number of visible data display pages 210 rapidly displayed in sequence by the fast scrolling program 118 to mimic scrolling up or down or left or right.

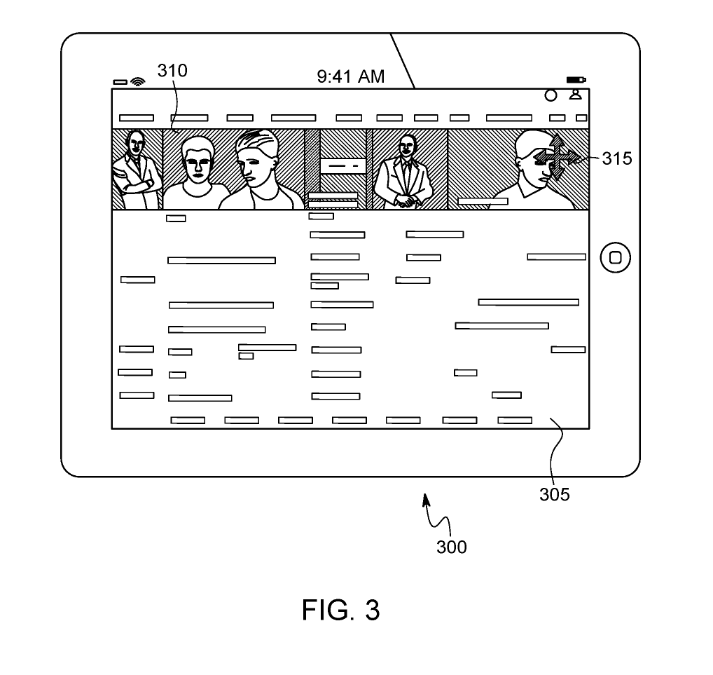

Referring to FIG. 3, the depicted tablet 300 displays a webpage 305. In the upper right hand corner of the webpage 305, an interactive touch sensitive directional fast scrolling icon 315 is visible and active. As depicted, the interactive touch sensitive directional fast scrolling icon 315 can comprise opposing arrow-shaped pairs of icon 315; one pair pointing up and down and one pair pointing left and right. Other functional geometric icons may be created and used as the directional fast scrolling icon 315, and the fast scrolling program 118 may allow for selection from among several available geometric, functional icons. The fast scrolling icon 315 may also be activated and used by external hardware 140. In the case of a mouse 148, the fast scrolling icon mimics the action of the wheel typically found on the top of mouse 148, but with a faster rate of scrolling.

The fast scrolling icon 315 can be selectively hidden or visible as the program operates in the background. The arrows of the fast scrolling icon 315 can be set to “hidden” and disappear from view with the program running in the background. Thus, once activated, the user can tap anywhere on touch sensitive screen 205 and the scrolling movement would behave the same. Therefore, in an embodiment, a user can tap and hold anywhere on touch sensitive screen 205 to activate fast scrolling program 118 to move pages faster than finger 225 or mouse 148 manipulation can scroll webpage 305. Double-taps applied at configured locations on the display (e.g., upper right corner) can be used to activate fast scrolling program 118.

The invention has been described herein using specific embodiments for the purpose of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A computer device, comprising:
a central processing unit, a memory accessible by the processing unit, and a touch sensitive display screen for displaying received data and providing a graphical user input for controlling the computer device;
a communication module for communicating over the internet and providing for communicating data between the computer device and a website hosted on a computer server;
a fast scrolling program stored in said memory;
wherein the fast scrolling program, when active, processes visual data using inputs on the touch sensitive display allowing for fast manipulation of data for changing the displayed data at a rate of at least 5 pages of displayed data per second; and
wherein the manipulation of the displayed data corresponds to a directional input from a touch sensitive directional icon controlling the data processing of the visual data for display.

2. The computer device of claim 1, wherein the fast scrolling program activates via a drop down menu.

3. The computer device of claim 1, wherein the fast scrolling program activates via a pop up on the touch sensitive display screen.

4. The computer device of claim 1, wherein the scrolling program directional input can be accomplished using a least one of
a) a finger;
b) an input from an external mouse; and
c) an input from an external keyboard.

5. The computer device of claim 1, wherein the touch sensitive directional icon comprises two opposing pairs of directional arrows, with a first pair oriented in an up and down configuration and a second pair oriented in a left and right configuration.

6. The computer device of claim 1, wherein the computer device comprises a tablet or a smart phone.

7. A method of operating a computer device to process visual data, comprising:
providing a central processing unit, a memory accessible by the processing unit, a touch sensitive display screen for displaying received data, and a user interface input controlling the computer device;
communicating with a website server to access and retrieve webpage visual data;
activating a fast scrolling program stored in said memory;
processing the visual data received from a website server using the fast scrolling program, wherein the fast scrolling program using inputs to the processing unit for fast manipulation of data to change the displayed data at a rate of at least 5 pages of displayed data per second; and
wherein the manipulation of the displayed data corresponds to a directional input from a user interface controlling the data processing of the visual data for display.

8. A computer device accessing a webpage, comprising:
a central processing unit, a memory accessible by the processing unit, a display for displaying received data, and a user interface for controlling the computer device;
a communication module for communicating over the internet and providing for communicating data between the computer device and a webpage hosted on a computer server;
a fast scrolling program stored in said memory;
wherein the fast scrolling program, when active, processes visual data using inputs from the user interface allowing for fast manipulation of data for processing data to change the displayed data at a rate of at least 5 pages of displayed data per second; and
wherein the manipulation of the displayed data corresponds to a directional input from the user interface controlling the data processing of the visual data for display.

9. The computer device accessing a webpage of claim 8, wherein the user interface comprises a touch sensitive display screen, a keyboard, or a mouse.
